(19) United States
(12) Patent Application Publication
(10) Pub. No.: US 2013/0108865 A1
(43) Pub. Date: May 2, 2013

(54) MATERIAL INCLUDING NANOTUBES OR NANOWIRES GRAFTED IN A MATRIX, METHOD FOR PREPARING SAME AND USES THEREOF

(71) Applicants: Pascal Boulanger, Eguilles (FR); Alexandre Brouzes, Gif sur Yvette (FR); Guy Claude Denis Deniau, Les Essarts le Roi (FR); Martine Mayne-L'Hermite, Les Molieres (FR); Marion Mille, Reims (FR); Mathieu Pinault, Antony (FR)

(72) Inventors: Pascal Boulanger, Eguilles (FR); Alexandre Brouzes, Gif sur Yvette (FR); Guy Claude Denis Deniau, Les Essarts le Roi (FR); Martine Mayne-L'Hermite, Les Molieres (FR); Marion Mille, Reims (FR); Mathieu Pinault, Antony (FR)

(73) Assignee: COMMISSARIAT A L'ENERGIE ATOMIQUE ET AUX ENERGIES ALTERNATIVES, Paris (FR)

(21) Appl. No.: 13/807,180

(22) PCT Filed: Jul. 4, 2011
(86) PCT No.: PCT/EP11/61239

§ 371 Date: Jan. 3, 2013

(30) Foreign Application Priority Data
Jul. 2, 2010 (FR) 1055404

(51) Int. Cl. B29C 70/68

(52) U.S. Cl. CPC B29C 70/682; B82Y 30/00
USPC 428/340; 428/221; 264/261; 264/494; 264/490; 205/114; 977/778

(57) ABSTRACT

The present invention relates to a material comprising (i) nanotubes or nanowires aligned with each other in a vertical matrix and (ii) a matrix arranged between the nanotubes or the nanowires, at least one organic polymer being covalently grafted to at least two of said nanotubes or to at least two of said nanowires. The present invention also relates to a method for preparing such a material or to its uses.

### TECHNICAL FIELD

The present invention relates to the field of nanotechnologies and more particularly, to the field of materials containing nano-objects such as nanowires or nanotubes.

Thus, the present invention relates to a novel material consisting of an assembly of nanotubes (or nanowires) notably aligned, in a matrix, the nanotubes/matrix (or nanowires/matrix) interface of which is controlled by introducing a specific sublayer between the nanotubes (or nanowires) and the filling matrix.

The present invention not only relates to such a material but also to its preparation method and to its different uses.

STATE OF THE PRIOR ART

Nano-objects are presently becoming particularly popular because of their original and exacerbated properties as compared with conventional materials. Indeed, nano-objects have many benefits both as regards their structures and their physical properties and their potential applications notably in membranes or in any other physical separation device, electrodes, composite materials, thermal, optical or electronic devices, as well as catalyst supports and devices for storing or converting chemical, light, electrical, mechanical energy etc. . . . .

In the field of membrane applications, it has been predicted by simulation and experimentally demonstrated that, under certain conditions, the flow rate of water in the core of carbon nanotubes may be up to 1,000 times faster than the velocity predicted by standard diffusion laws [1]. This is also the case but at lesser degrees for neutral or ionic liquids and gases. The making of membranes based on aligned nanotubes has been demonstrated experimentally and this with several methods.

Thus, the article of Hinds et al., 2004 describes direct growth of a carpet of multiwalled carbon nanotubes (CNT) aligned by chemical vapor deposition or CVD by implementing a catalyst consisting of Fe nanocrystals [2]. Such direct growth may also be obtained without pre-depositing a catalyst and this, notably by using the DLI-CVD ( [symbol] Direct Liquid Injection—Chemical Vapor Deposition [symbol] ) method [3]. The internal diameter of the nanotubes is 7 nm on average. A more complicated method, based on pre-deposition of a fine layer of catalyst, for example Fe, followed by CVD synthesis gives the possibility of obtaining carpets of double-sheeted nanotubes themselves also aligned, the internal core diameter is of the order of 2 nm [4].

Also, dispersed carbon nanotubes, often single-walled nanotubes, may either be assembled by specific functionalization of the heads of the tubes and then by impregnation in a polymer [5], or by self-assembly perpendicular to a surface, most often Si [6] but also by Langmuir-Blodget techniques [7] or the techniques derived thereof at the interface of liquids [8] or by applying a magnetic field. Such methods are used for assembling other shapes of nanotubes such as nanotubes of imogolites.

The impregnation of CNT carpet is achieved with actually aligned carpets. The carpets are impregnated with a most often polymeric matrix with techniques:

(1) for deposition by centrifugation known under the name of [symbol] spin-coating [symbol] with polystyrene [2] or poly(methyl-methacrylate) (PMMA) [10];

(2) of CVD deposition with parylene [11] or with silicon nitride (Si₃N₄) [6], or

(3) of impregnation under reduced pressure in a single step.

The impregnation may either be total or partial. For total impregnation, at least the whole of the thickness of the carpet and even more is impregnated. Within the scope of partial impregnation, the carpet may only be partly filled with at least one or several [symbol] slices [symbol] or [symbol] areas [symbol] of matrix which ensure the maintaining thereof. These [symbol] slices [symbol] or [symbol] areas [symbol] may either be superposed or not, thereby delimiting an empty space between them in which a material flow pass through perpendicularly to the axis of the nanotubes. The matrix which fills the inter-nanotube space is treated in the same way whether it is a polymeric matrix or a ceramic matrix. It should be emphasized that the interface between the notably polymeric matrix and the CNTs only result from low and experienced interactions such as physisorption of the polymer on the CNTs. Little information is given on the quality of this impregnation, on its defects, on its possible orientation, on its imperviousness relatively to the diffusion of liquids or gases and on its mechanical adhesion to the CNTs or to the nanowires.

International application WO 2007/025104 describes membranes and a method for preparing such membranes comprising the making of vertically aligned CNTs notably by CVD and then the filling of the empty spaces between the CNTs with a matrix [9].

Further, International application WO 2008/028155 proposes a composite membrane comprising dispersed CNTs which are aligned so that they are parallel to the flow passing through the membrane [12]. This alignment is accomplished via a filtration technique. The aligned CNTs are impregnated with a polymeric matrix notably by spin-coating. Even if functionalization of the CNTs is considered, this functionalization which applies simple chemical groups is used for modifying the solubility of CNTs in specific solvents and/or for promoting their alignment.

U.S. Pat. No. 7,611,628 proposes a pervious membrane, the making of which implies steps for aligning the CNTs and for impregnating aligned CNTs with a polymeric matrix [13]. To these steps, is added the etching of the membrane (i) so as to remove the matrix excess from the surface of the membrane and thereby open the CNTs and generate pores and (ii) so as to oxidize the end of the CNTs by generating carboxylate groups. The thereby formed carboxylate groups may react with functional units comprising an amine group and this in order to alter the flow through the actual nanotubes.

In other fields and in particular in the field of electrodes and of composite materials, the nanotubes are not necessarily aligned, or ordered in any way. On the contrary, they are often [symbol] dispersed [symbol] . The composites are in majority prepared with pressure- and/or temperature-assisted techniques. Today, the most promising composites in terms of development are those with a polymeric matrix, of interest for applications with high added value notably in fields such as aerospace or energy, as well as for the industry of conductive plastics.

The literature reports a large number of studies on the subject, showing an increase in the electrical, thermal and mechanical properties which nevertheless does not prove to be systematic [14]. While the CNTs generally generate an increase in electric conduction by forming a percolating network resulting from the high form factor of CNTs [15], they are not as efficient in terms of mechanical and thermal properties [16]. This essentially results from the poor dispersion of CNTs in the matrix and from the poor quality of the CNT/matrix interface in terms of chemical compatibility. More specifically, in the case of membranes based on CNTs, their mechanical fragility is often related and imposes that these membranes be tested on solid and pervious supports.

Therefore, it proves to be extremely important to perfectly control the dispersion and distribution of the CNTs in the matrix and the nature of the interface. Investigations, conducted in this direction, show improvements in the mechanical, thermal and even electrical properties. Research work also shows compliant impregnations on CNTs [17] but there also the impregnation is not covalent.

The inventors set the goal of proposing a material comprising nanotubes but also nanowires and a matrix in which the interface between the nanotubes (or nanowires) and the matrix is better controlled and this in order to improve the mechanical, electrical, thermal, optical, chemical or perviousness properties of the thereby obtained material.

### DISCUSSION OF THE INVENTION

With the present invention it is possible to solve the technical problems as defined earlier and to achieve the goal set by the inventors.

Indeed, the work of the inventors gave the possibility of showing that by adding an adhesion layer covalently bound to the nanotubes, notably aligned, prior to their impregnation with (or their incorporation into) a matrix, notably a polymeric matrix, it is possible to improve the interface between nanotubes and matrix.

The adhesion layer applied within the scope of the invention is a polymeric coating which has the innovations described hereafter, this coating being covalently grafted to the nanotubes.

First of all, the method used for preparing this adhesion layer, i.e. any technique with which an organic polymer may be grafted on nanotubes, does not perturb the alignment of the nanotubes. As illustrative and non-limiting examples, this technique may consist in chemical radical grafting, electro-grafting or radio-grafting.

Further, the fact that the adhesion layer is covalently grafted on the surface of the nanotubes reinforces the bond with the nanotubes and therefore allows better adhesion of the matrix, a so-called [symbol] filling matrix [symbol] , onto the nanotubes. Indeed, during the impregnation step, the filling matrix strongly interacts with the layer grafted earlier. The thereby obtained interpenetrated network improves the quality of the nanotube/matrix interface and reinforces the mechanical properties of the membrane.

Further, this interpenetration may be accompanied by physisorption but also by chemisorption making the interactions between the adhesion layer and the filling matrix stronger. Within the scope of chemisorption, ionic bonds or covalent bonds may exist, involving one atom from the adhesion layer and one atom from the material forming the filling matrix.

Thus, a better interface between the sub-layer and the matrix is expressed by better mechanical strength and better imperviousness of the inter-nanotube space (or inter-tube space). In the case of filling matrices of the polymeric type, the stronger interpenetration of the chains of polymers of the sub-layer with the chains of the material forming the filling matrix promotes continuity between these chains.

The improvement of the nanotubes/matrix interface also reduces the diffusion paths of the liquids and/or of the gases in the material and both allows better imperviousness of the intertube space when this is sought, and also better selectivity while avoiding that the species for which sorting is desired, do not mix again thanks to these secondary diffusion paths.

The use of a suitable adhesion and functionalization layer allows better compatibility with the material of the filling matrix and the filling with this matrix of the inter-nanotube space may be partial or total. Thus, partial filling of the inter-tube space may be used for changing the hydrophobicity of the nanotubes and for controlling their wettability but also for generating a layer of adsorption sites in order to transform the nanotubes and notably the carpet which they form into a sensor, an electrode, or a selected filter.

Finally, the present invention is remarkable in that it applies not only to any type of nanotubes but also to nanowires. Thus, all of what has been described earlier for nanotubes also applies to nanowires.

The present invention relates to a material comprising (including):
at least two nanotubes or at least two nanowires on which at least one organic polymer is covalently grafted and
one matrix arranged between the nanotubes or the nanowires.

More particularly, the present invention relates to a material comprising:
nanotubes or nanowires aligned with each other in a vertical matrix and
a matrix arranged between the nanotubes or the nanowires,

at least one organic polymer being covalently grafted to at least two of said nanotubes or to at least two of said nanowires.

Within the scope of the present invention, by [symbol] nanotube [symbol] is meant a tubular and/or cylindrical structure, the internal diameter of which varies between 0.5 nm and 100 nm, notably between 0.5 nm and 50 nm and, more specifically, for nanofiltration applications between 0.5 nm and 10 nm. The nanotubes applied within the scope of the present invention may be inorganic nanotubes, organic nanotubes or a mixture of inorganic nanotubes and of organic nanotubes.

The inorganic nanotubes may be selected from the group consisting of imogolite nanotubes, boron nitride (BN) nanotubes, zinc oxide (ZnO) nanotubes, gallium nitride (GaN) nanotubes, silicon nitride (Si₃N₄) nanotubes, tungsten bisulfide (WS₂) nanotubes, molybdenum bisulfide (MoS₂) nanotubes, tungsten selenide (WSe₂) nanotubes, molybdenum selenide (MoSe₂) nanotubes, titanium dioxide (TiO₂) nanotubes or molybdenum trioxide (MoO₃) nanotubes or one of their mixtures.

Organic nanotubes may be selected from the group consisting of carbon nanotubes, peptide nanotubes, cyclic peptide nanotubes, transmembrane molecule nanotubes, crown ether nanotubes, porphyrin nanotubes, aquaporin nanotubes, gramicidin nanotubes, polymeric nanotubes, nanotubes formed by self-assembling of organic molecules or one of their mixtures.

A carbon nanotube is defined as a concentric winding of one or more graphene (paving of carbon hexagons) layers. These are referred to as
single-sheet nanotubes, single-wall nanotubes or SWNT when there is a single graphene layer;
double-sheet nanotubes, double-wall nanotubes or DWNT in the case of two graphene layers;
multi-sheet nanotubes, multi-wall nanotubes or MWNT in the case of several graphene layers.

The present invention applies to any type of carbon nanotubes and this regardless of their preparation method. Thus, the carbon nanotubes applied within the scope of the present invention may be nanotubes with a single graphene layer (SWNT), nanotubes with two graphene layers (DWNT), nanotubes with several layers of graphene (MWNT) or one of their mixtures.

One skilled in the art is aware of various methods with which nanotubes as defined earlier may be prepared. As more particular examples of methods with which carbon nanotubes may be prepared, mention may be made of physical processes based on sublimation like electric arc, laser ablation methods or using a solar oven and chemical processes such as the CVD method or consisting in pyrolyzing carbonaceous sources on metal catalysts.

It should be noted that covalent grafting of an organic polymer on SWNTs modifies their electrical properties, and therefore potentially the surface charge, and consequently water flow.

Within the scope of the present invention, by [symbol] nanowire [symbol] is meant a one-dimensional or a substantially one-dimensional structure having a thickness or a diameter varying from 0.5 nm to 1,000 nm, notably from 1 nm to 500 nm and in particular between 2 nm and 50 nm.

The nanowires applied within the scope of the present invention may be inorganic nanowires, organic nanowires or a mixture of inorganic nanowires and of organic nanowires.

The nanowires applied within the scope of the present invention are notably selected from the group consisting of gold (Au) nanowires, silver (Ag) nanowires, nickel (Ni) nanowires, platinum (Pt) nanowires, silicon (Si) nanowires, gallium nitride (GaN) nanowires, indium phosphide (InP) nanowires, silicon dioxide (SiO₂) nanowires, titanium dioxide (TiO₂) nanowires, zinc oxide (ZnO) nanowires, 1,5-diaminoanthraquinone nanowires, DNA (DeoxyriboNucleic Acid) nanowires, nanowires consisting of nanotubes as defined earlier or one of their mixtures.

One skilled in the art is aware of various methods with which such nanowires may be prepared. These methods consist in etching a substrate with lithography or etching techniques, or by growing the nanowire with CVD methods from thin metal films such as gold or of assembling nanotubes.

The (two) nanowires may be used in the present invention combined with at least one nanotube as defined earlier.

More particularly, the present invention may apply a plurality of nanotubes; a plurality of nanowires; a plurality of nanotubes combined with at least one nanowire; a plurality of nanowires combined with at least one nanotube or further a plurality of nanotubes combined with a plurality of nanowires.

The nanotubes and the nanowires within the scope of the present invention may have any chirality and any length. Advantageously, the nanotubes and nanowires and notably the plurality of nanotubes and the plurality of nanowires applied within the scope of the present invention are nanotubes and nanowires having a length comprised between 10 nm and 2 cm, notably between 20 nm and 1 mm, in particular between 50 nm and 100 μm and, most particularly, between 100 nm and 50 μm.

In the material according to the present invention, the nanotubes or nanowires may have, relatively to each other, an aligned, degraded or dispersed conformation. By [symbol] degraded conformation [symbol] is meant substantially straight nanotubes or nanowires but not necessarily aligned with each other.

On the contrary, in the case of an aligned conformation, the nanotubes or the nanowires are used aligned with each other in a vertical matrix for a [symbol] vertical array [symbol] . In this conformation, they are generally and substantially perpendicular to a support. One refers to [symbol] carpets [symbol] , [symbol] forests [symbol] or [symbol] networks [symbol] of nanotubes or nanowires. An aligned conformation may be obtained as soon as the preparation of the nanotubes or of the nanowires or once the latter have been prepared notably by filtration techniques in the core of nanotubes as described in International application WO 2008/028155 [12] or by techniques with a flow transverse to the axis of the tubes as described in patent application US 2004/0173506 [18] and International application WO 2009/141528 [19].

The density of nanotubes (or of nanowires) in the material according to the present invention may be variable. The latter is advantageously comprised between 10⁴ and 10¹³ nanotubes (or nanowires)/cm² of material. As explained earlier, the method used for preparing the adhesion layer does not perturb the alignment of the nanotubes or of the nanowires. Also, it is possible to have a material having a dense carpet of aligned nanotubes or nanowires, with of the order of 10⁹ to 10¹³ nanotubes (or nanowires)/cm² and notably of the order of 10⁹ to 10¹¹ nanotubes (or nanowires)/cm². Advantageously, the obtained maximum misalignment, following covalent grafting of the organic polymers, for a dense carpet of nanotubes or nanowires is of 10 degrees and the maximum tortuosity is 3%, and in particular a 5% misalignment for a tortuosity of 1%.

Also, for straight nanotubes or nanowires but not aligned with each other, the method used for preparing the adhesion layer does not perturb the tortuosity of the nanotubes and of the nanowires which remain straight. In this case, the obtained maximum tortuosity is 3% and notably 1%.

Alignment and tortuosity of the nanotubes or nanowires are parameters which are accessible by measurement with X-rays and notably as described in the article of Pichot et al., 2006 [20] and in the article of Pichot et al., 2004 [31].

Within the scope of the present invention, the nanotubes and nanowires are grafted (or functionalized or derivatized) with at least one organic polymer. More particularly, at least 50%, at least 60%, at least 70%, at least 80%, at least 90%, at least 95%, at least 96%, at least 97%, at least 98% and at least 99% of the nanotubes and of the nanowires are grafted (or functionalized or derivatized) with at least one organic polymer. Advantageously, at least one organic polymer is grafted on each nanotube (or each nanowire). The grafted polymers form the adhesion layer as defined earlier.

By [symbol] organic polymer [symbol] , is meant a polymer for which the main chain mainly comprises carbon atoms but may also comprise heteroatoms such as oxygen atoms and nitrogen atoms.

This organic polymer is advantageously covalently grafted on the side portion of the nanowires and on the side external portion of the nanotubes. This grafting may be localized on limited and defined areas of these surfaces.

Each grafted (or functionalized or derivatized) nanowire and nanotube, with at least one organic polymer may comprise at least two, at least five, at least ten, at least 20, or at least 100 grafted organic polymers, each grafted organic polymer on a same nanotube or on a same nanowire may have a sequence of units identical with that of grafted polymer(s) or different from each other (or from the others). Also, the organic polymers grafted on different nanotubes or nanowires may have an identical sequence of units for all the nanotubes or all the nanowires or a different one.

The organic polymer applied within the scope of the present invention comprises
at least one unit derived from a cleavable aryl salt, and/or
at least one unit derived from a monomer having at least one bond of the ethylenic type, and/or
at least one unit derived from a monomer having at least two carboxylic functions, and/or
at least one unit derived from a monomer having at least two amine functions and/or
at least one unit derived from a monomer having a carboxylic function and an amine function. The organic polymer applied within the scope of the present invention advantageously consists of recurrent pattern units corresponding to such units.

The adhesion layer formed by the organic polymers grafted on the nanotubes or the nanowires may contain another nanoscopic material, notably such as metal or platinum nanoparticles.

Advantageously, the organic polymer applied within the scope of the present invention is substituted with at least one reactive function. By [symbol] reactive function [symbol] is meant, within the scope of the present invention, a function selected from a carboxyl function (which may react with an amine or alcohol function), an aryl group (such as pyrene, naphthalene or polyaromatics), a radical entity, a hydroxyl function or an alcohol function (which may react with a carboxyl or isocyanate function), an amine function (which may react with an ester function), an ester function (which may react with an amine function), an aldehyde function (which may react with a hydrazide function), a hydrazide function (which may react with an aldehyde function), a ketone function (which may react with two alcohol functions with view to acetalization), an epoxy function (which may react with an amine function), an isocyanate function (which may react with a hydroxyl function), a maleimide function (which may react with a thiol function, an amine function or a diene function), a diene function (which may react with a maleimide function) and a thiol function (which may react with a maleimide function or another thiol function).

By [symbol] cleavable aryl salt [symbol] , is meant within the scope of the present invention a cleavable aryl salt selected from the group consisting of diazonium aryl salts, ammonium aryl salts, phosphonium aryl salts, iodonium aryl salts and sulfonium aryl salts. In these salts, the aryl group is an aryl group which may be represented by R as defined hereafter.

These cleavable aryl salts are capable, under certain non-electrochemical or electrochemical conditions, of either forming radicals or ions, and particularly cations, and thereby participate in chemical reactions. Such chemical reactions may notably be chemisorption reactions and in particular chemical grafting or electrografting. Thus, such a cleavable aryl salt is capable, under non-electrochemical or electrochemical conditions of being chemisorbed on the surface of a nanowire or of a nanotube, notably by a radical reaction, and of having another function reactive towards another radical after this chemisorption.

Alternatively, once the cleavable aryl salt is chemisorbed at the surface of the nanotubes or of the nanowires, it may have a function reactive towards another reactive function capable of forming with the first a covalent or ionic bond, both identical or different reactive functions being as defined earlier. The second reactive function may either be borne by the organic polymer to be grafted on the nanotube or on the nanowire, or by the material forming the filling matrix.

It should be noted that cleavable aryl salts may be described as polymerizable insofar that, by a radical reaction, they may lead to the formation of molecules with a relatively high molecular weight, the structure of which is essentially formed of units with multiple recurrences derived, in fact or from a conceptual point of view, from molecules of cleavable aryl salts. An organic polymer which may be grafted on the nanotubes or on the nanowires, within the scope of the present invention, may therefore be a polymer consisting of recurrent pattern units corresponding to units derived from one (or more) cleavable aryl salt(s).

Among cleavable aryl salts, mention may in particular be made of the compounds of the following formula (I):

R—N₂⁺, A⁻ (I)

wherein:
A represents a monovalent anion and
R represents an aryl group.

By [symbol] aryl group [symbol] is meant within the scope of the present invention, and notably for the reactive functions and the aryl groups of cleavable aryl salts, an aromatic or heteroaromatic carbonaceous structure, optionally mono- or poly-substituted, consisting of one or more aromatic or heteroaromatic rings each including from three to eight atoms, the heteroatom(s) may be N, O, P or S. The substituent(s) may contain one or more heteroatoms, such as N, O, F, Cl, P, Si, Br or S as well as C₁-C₆ alkyl groups or C₄-C₁₂ thioalkyl groups notably.

Within cleavable aryl salts and notably within the compounds of formula (I) above, R is preferably selected from aryl groups substituted with reactive functions as defined earlier and/or with electron attractor groups such as NO₂, ketones, CN, CO₂H, Br and esters.

Within the compounds of formula (I) above, A may notably be selected from inorganic anions such as halides like I⁻, Br⁻ and Cl⁻, halogenoborates such as tetrafluoroborate, perchlorates and sulfonates and organic anions such as alcoholates and carboxylates.

As compounds of formula (I), it is particularly advantageous to use a compound selected from the group consisting of 4-nitrobenzenediazonium tetrafluoroborate, tridecylfluorooctylsulfamylbenzene diazonium tetrafluoroborate, phenyldiazonium tetrafluoroborate, 4-nitrophenyldiazonium tetrafluoroborate, 4-bromo-phenyldiazonium tetrafluoroborate, 4-amino-phenyldiazonium chloride, 2-methyl-4-chloro-phenyldiazonium chloride, 4-benzoylbenzenediazonium tetrafluoroborate, 4-cyanophenyldiazonium tetrafluoro-borate, 4-carboxyphenyldiazonium tetrafluoroborate, 4-acetamidophenyldiazonium tetrafluoroborate, 4-phenyl-acetic acid diazonium tetrafluoroborate, 2-methyl-4-[(2-methylphenyl)diazenyl]benzenediazonium sulfate, 9,10-dioxo-9,10-dihydro-1-anthracenediazonium chloride, 4-nitronaphthalenediazonium tetrafluoroborate, naphthalenediazonium tetrafluoroborate.

By [symbol] monomer having at least one bond of the ethylenic type [symbol] , is advantageously meant a monomer having a vinyl unsaturation, an allylic unsaturation and/or an acrylic unsaturation.

Such monomers are selected from the monomers of the following formula (II):

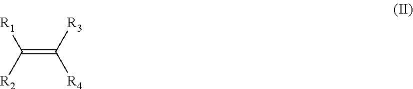

wherein the groups R₁ to R₄, either identical or different, represent a monovalent non-metal atom such as a halogen atom, a hydrogen atom, a saturated or unsaturated chemical group, such as an alkyl, aryl group, a —COOR_{S} group wherein R₅ represents a hydrogen atom or a C₁-C₁₂ alkyl group and preferably a C₁-C₆ alkyl group, a nitrile, a carbonyl, an amine or an amide.

The compounds of formula (II) above are in particular selected from the group consisting of vinyl acetate, acrylonitrile, methacrylonitrile, methyl methacrylate, ethyl methacrylate, butyl methacrylate, propyl methacrylate, hydroxyethyl methacrylate, hydroxypropyl methacrylate, glycidyl methacrylate and derivatives thereof; acrylamides and notably amino-ethyl, propyl, butyl, pentyl and hexyl methacrylamides, cyanoacrylates, diacrylates and dimethacrylates, triacrylates and trimethacrylates, tetraacrylates and tetramethacrylates (such as pentaerythritol tetramethacrylate), styrene and its derivatives, para-chlorostyrene, pentafluorostyrene, N-vinylpyrrolidone, 4-vinylpyridine, 2-vinylpyridine, vinyl, acryloyl or methacryloyl halides, divinylbenzene (DVB), and more generally vinyl cross-linking agents or based on acrylate, methacrylate, and derivatives thereof.

Advantageously, the monomers having at least one ethylenic bond applied with the scope of the present invention are substituted with at least one reactive function as defined earlier.

In the material according to the present invention, the matrix which is positioned between the grafted nanotubes and/or nanowires i.e. the filling matrix may be selected from the group consisting of a ceramic matrix, a polymeric matrix, a matrix stemming from biomass or a matrix stemming from cellulose derivatives and mixtures thereof.

By [symbol] ceramic matrix [symbol] is more particularly meant a matrix, for which the material making it up is selected from the group consisting of silicon nitride, aluminium nitride, titanium nitride, aluminium carbide, titanium carbide, silicon carbide, silicon oxide, silicon dioxide, magnesium oxide, cerium oxide, alumina, titanium oxide, bismuth oxide, beryllium oxide, hydroxyapatite or one of their mixtures.

The polymer matrix applied within the scope of the present invention may consist of one (or more) thermoplastic polymer(s), one (or more) thermosetting polymer(s), one (or more) glassy polymer(s) or one of their mixtures. By [symbol] polymeric matrix [symbol] , is more particularly meant a matrix for which the material making it up is selected from the group consisting of a polyamide, polyimide, parylene, polycarbonate, polydimethyl-siloxane, polyolefin, polysulfone, polyethersulfone, polyetheretherketone (PEEK) and derivatives thereof, polypropylene (PP), polyvinylidene fluoride (PVDF), polyvinylpyrrolidone (PVP), cellulose acetate, an acrylic resin, a polystyrene, polymethylmethacrylate, polymethacrylate, an epoxy resin, polyester, acetylnitrile-butadiene-styrene terpolymer or one of their mixtures.

When the filling matrix is a polymeric matrix, it is possible that the monomers used for preparing it are identical with the monomers used for preparing the organic polymer grafted to the nanotube or to the nanowire.

Further, the filling matrix and notably when this is a polymeric matrix, the material making it up may be substituted with at least one reactive function as defined earlier.

The filling matrix may be non-porous or porous. Indeed, a porous matrix of the polyamide, polysulfone, polyestersulfone, PP, PVDF, PVP or cellulose acetate type may particularly be of interest when the material according to the invention is used for applications for desalting sea water or brackish water.

The present invention also relates to a method for preparing a material as defined earlier. This method comprises the successive steps of:

a) grafting, on at least two nanotubes from among nanotubes aligned with each other in a vertical matrix or on at least two nanowires from among nanowires aligned with each other in a vertical matrix, an either identical or different organic polymer,

b) positioning between the nanotubes and the nanowires obtained following step (a), a matrix as defined earlier.

During step (a) of the method according to the present invention, any technique allowing grafting of an organic polymer may be used. The latter is advantageously selected from functionalization of the nanotubes or of the nanowires followed by coupling with an organic polymer; radical chemical grafting; electrografting; photografting; grafting by radical polymerization with transfer of atoms or ATRP (Atom Transfer Radical Polymerization); grafting by radical polymerization controlled by nitroxide or NMRP (Nitroxide Mediated Radical Polymerization); grafting by radical polymerization by addition fragmentation such as RAFT (Reversible Addition Fragmentation Chain Transfer) method, or MADIX (Macromolecular Design via Interchange of Xanthan) method; vapor phase grafting or grafting activated with microwaves.

In a first alternative of the present invention, the grafting applied during step (a) of the method may consist in (a₁) functionalization of the nanotubes or of the nanowires followed (b₁) by coupling with an organic polymer.

Functionalization of the nanotubes or nanowires consists in generating reactive functions as defined earlier on nanotubes or nanowires, by subjecting them to conditions allowing the formation of such reactive functions. Advantageously, the reactive function formed at the surface of a nanotube or a nanowire during this functionalization has
a group selected from a carboxyl function, an aryl group of the polyaromatic aryl type, a radical entity, a hydroxyl function, an alcohol function, an amine function, an ester function, an aldehyde function, a hydrazide function, a ketone function, an epoxy function, an isocyanate function, a maleimide function, a diene function or a thiol function or
an alkyl group substituted with such a group.

There exist reviews in the literature on the covalent functionalization of nanotubes and notably of carbon nanotubes [21].

A few examples of methods which may be applied during this functionalization are found here, generating reactive functions at the surface of nanotubes or nanowires and allowing subsequent grafting of organic polymers:
an oxidizing treatment of the nanotubes or nanowires;
arylation of the nanotubes and notably of carbon nanotubes or nanowires with diazonium [22];
functionalization of nanotubes or nanowires by 13-dipolar cycloaddition [23];
functionalization of nanotubes or nanowires by [2+1] cycloaddition [24].

By [symbol] oxidizing treatment [symbol] , is meant within the scope of the present invention, a treatment (or pre-treatment) aiming at oxidizing the surface of the applied nanotubes or nanowires and/or at preparing the surface for future oxidation by forming radicals. An oxidation modifies the surface of the nanotubes or nanowires notably by attaching and/or introducing, on the ends or defects of the nanotubes or nanowires, oxygen-rich groups such as groups of the carboxylic (—COOH), hydroxyl (—OH), alkoxyl (—OX with X representing an alkyl group, an acyl group or an aroyl group), carbonyl (—C═O), percarbonic (—C—O—OH) type or sometimes amide (—CONH) type.

Such an oxidizing treatment is based on two main types of surface modifications based on:
physical treatments such as treatment with a plasma notably an oxygen plasma, UV treatment, treatment with X or gamma rays, treatment by irradiation with electrons and with heavy ions or
chemical treatments such as treatment with alcoholic potash, treatment with a strong acid (HCl, H₂SO₄, HNO₃, HlO₄), treatment with soda, treatment with a strong oxidizer (KMnO₄, K₂Cr₂O₇, KClO₃ or CrO₃ in hydrochloric acid, sulfuric acid or nitric acid) and ozone treatment.

It should be noted that an oxidizing pre-treatment as defined earlier may be applied and this regardless of the grafting technique used subsequently.

These nanotubes and these nanowires, bearing one or more reactive functions as defined earlier, may then directly react with one or more organic polymers as defined earlier and having at least one other reactive function capable of reacting with the one(s) grafted on the nanotubes or the nanowires during the functionalization step.

As an illustrative and non-limiting example, this alternative may use an aryl diazonium salt bearing an amine function for functionalizing the surface of the nanotubes or of the nanowires and an organic polymer of the polyamide type which is chemisorbed via this amine function.

In a second alternative, the grafting step may consist in a radical chemical grafting.

The term of [symbol] radical chemical grafting [symbol] notably refers to the use of extremely reactive molecular entities typically radicals, capable of forming bonds of the covalent bond type with a surface of interest, said molecular entities being generated independently of the surface on which they are intended to be grafted. Thus, the grafting reaction leads to the formation of covalent bonds between the area of the surface of the nanotube or of the nanowire on which the organic polymer has to be grafted and the derivative of the cleavable aryl salt as defined earlier.

Advantageously, this second alternative comprises the steps of:

a₂) putting the nanotubes or the nanowires in contact with a solution S₁ comprising at least one cleavable aryl salt as defined earlier and optionally at least one monomer having at least one bond of the ethylenic type as defined earlier;

b₂) subjecting said solution S₁ to non-electrochemical conditions allowing the formation of radical entities from said cleavable aryl salt.

The organic polymer obtained following the application of this second alternative of step (a) may comprise either exclusively units derived (or stemming) from one (or more) cleavable aryl salt(s), or at least one unit derived (or stemming) from a cleavable aryl salt and at least one other unit derived (or stemming) from a monomer having at least one bond of the ethylenic type. In the latter case, the first unit of the organic polymer (i.e. the unit directly bound to the surface of the nanotube or of the nanowire) is derived from a cleavable aryl salt, the bond between the organic polymer and the surface of the nanotube or of the nanowire therefore involves an atom from a unit derived from a cleavable aryl salt and an atom from the surface of the nanotube or of the nanowire.

This second alternative may be applied with any type of nanotubes or nanowires i.e. whether they are insulators, semiconductors or electrical conductors. This alternative is based on the method described in International application WO 2008/078052 [25] and in the article of Mévellec et al. 2007 [26]. The International application WO 2008/078052 proposes that the solid support be a nano-object such as a nanotube and envisions functionalization of the organic film grafted on the solid support with a nano-object such as a nanotube. However, nothing in this application describes the technical effects or the advantages obtained by using the grafted organic film as an adhesion layer.

When the solution S₁ comprises a cleavable aryl salt and a monomer which is polymerizable via a radical route as defined earlier, it may further contain at least one surfactant and this notably for improving the solubility of this monomer. A specific description of surfactants which may be used within the scope of the invention is given in the International application WO 2008/078052 [25] to which one skilled in the arts may refer. A single surfactant or a mixture of several surfactants may be used.

One skilled in the art will be able to determine on the basis of the teaching of the International application WO 2008/078052 [25], the operating conditions to be used such as the concentration of cleavable aryl salt or of monomer which may be polymerized via a radical route in the solution S₁ or the pH of the latter.

Further, the cleavable aryl salt may, either be introduced as such into the solution S₁ as defined earlier, or be prepared in situ in the latter. Such compounds are generally prepared from arylamine, which may include several amine substituents, by reaction with NaNO₂ in an acid medium or with NOBF₄ in an organic medium. For a detailed discussion of the experimental methods which may be used for such a preparation in situ, one skilled in the art may refer to the article of Lyskawa and Belanger, 2006 [27]. Preferably, the grafting is then directly achieved in the solution for preparing the cleavable aryl salt.

By [symbol] non-electrochemical conditions [symbol] applied in step (b₂) of the method according to the invention, is meant within the scope of the present invention in the absence of any electric voltage. Thus, the non-electrochemical conditions applied in step (b₂) of the method according to the invention, are conditions which allow the formation of radical entities from the cleavable aryl salt, in the absence of the application of any electric voltage at the nanotubes or nanowires onto which the organic polymer is grafted and at the solution S₁. These conditions involve parameters such as for example the temperature, nature of the solvent, the presence of a particular additive such as a chemical initiator, the stirring, pressure when the electric current does not intervene during the formation of the radical entities. The non-electrochemical conditions allowing the formation of radical entities are numerous and this type of reaction is known and studied in detail in the prior art. One skilled in the art will be able to determine on the basis of the teaching of the International application WO 2008/078052 [25] the non-electrochemical conditions to be applied.

In a third alternative of the present invention, the grafting applied during step (a) of the method is electrografting.

By [symbol] electrografting [symbol] is meant within the scope of the present invention, an electro-initiated and localized grafting method for a cleavable aryl salt or a monomer having at least one bond of the ethylenic type, on a surface of electrically conductive and/or electrically semiconductive nanotubes or nanowires, by putting said cleavable aryl salts or monomers having at least one bond of the ethylenic type in contact with said surface. In this method, the grafting is achieved electrochemically in a single step. Said nanotubes or nanowires are brought to a potential greater than or equal to a threshold electric potential determined relatively to a reference electrode, said threshold electric potential being the potential beyond which grafting of said cleavable aryl salts or of said monomers having at least one bond of the ethylenic type occurs. Once said cleavable aryl salts are grafted or said monomers having at least one bond of the ethylenic type are grafted, they have another function which is reactive towards another radical and capable of triggering radical polymerization which does not depend on any electric potential.

Advantageously, this third alternative comprises the steps of:

a₃) putting the nanotubes or nanowires in contact with a solution S₂ comprising at least one cleavable aryl salt and/or at least one monomer having at least one bond of the ethylenic type;

b₃) biasing said nanotubes or said nanowires to a more cathodic electric potential than the reduction potential of the cleavable aryl salt or of the monomer having at least one bond of the ethylenic type applied in step (a₃).

All what has been described earlier for the solution S₁ i.e. the solvent, the amounts of cleavable aryl salts or of monomers having ethylenic unsaturation, the preparation of the cleavable aryl salt in situ and possibly the presence of a surfactant, also applies to the solution S₂.

According to the invention, it is preferable, when the solution S₂ comprises a cleavable aryl salt, that the electric potential used in step (b₃) of the method according to the present invention be close to the reduction potential of the applied cleavable aryl salt and which reacts at the surface. Thus, the value of the applied electric potential may be up to 50% higher than the reduction potential of the cleavable aryl salt, more typically it will not be greater than by 30%.

This alternative of the present invention may be applied in an electrolysis cell including different electrodes: a working electrode formed by the nanotubes or the nanowires and intended to receive the organic polymer, a counter-electrode, as well as optionally a reference electrode.

The biasing of the nanotubes or the nanowires may be carried out by any technique known to one skilled in the art and notably under conditions of linear or cyclic voltammetry, under potentiostatic, potentiodynamic, intensiostatic, galvanostatic, galvanodynamic conditions or by simple or pulsed chronoamperometry. Advantageously, the method according to the present invention is carried out under static or pulsed chronoamperometry. In the static mode, the electrode is biased for a duration generally less than two hours, typically less than one hour and for example less than 20 mins. In the pulsed mode, the number of pulses will be comprised, preferentially between 1 and 1,000 and, still more preferentially between 1 and 100, their duration being generally comprised between 100 ms and 5 s, typically 1 s.

In this third alternative, the obtained organic polymer may consist
exclusively of units derived (or stemming) from one (or more) cleavable aryl salt(s),
exclusively of units derived (or stemming) from one (or more) monomer(s) having at lest one bond of the ethylenic type,
of at least one unit derived (or stemming) from a cleavable aryl salt and of at least one other unit derived (or stemming) from a monomer having at least one bond of the ethylenic type.

Additional information on electrografting applied on nanotubes, notably carbon nanotubes may be obtained in the article of Tessier et al., 2008 [28].

In a fourth alternative of the present invention, the grafting applied during step (a) of the method is photografting. The applied photografting may be self-initiated or applied in the presence of initiators or photoinitiators such as a cleavable aryl salt as described earlier, dimethoxy-2,2-phenyl-2-acetophenone (DMPA), methoxy-2-phenyl-2-acetophenone (MPA), benzoyl peroxide, azobisisobutyronitrile (AIBN), ethoxy-2-phenylacetophenone (EPA) or benzophenone (BP). When photografting is carried out in the presence of photoinitiators, the latter may be immobilized at the surface of the nanotubes or of the nanowires or put into solution with the monomers which will give the organic polymer.

Alternatively, the self-initiated photografting and photopolymerisation (SIPGP) technique allows covalent grafting of polymer chains on the external surface of nanotubes or nanowires, from a mixture of monomers/nanotubes or nanowires.

UV radiation excites the molecules of monomers such as the monomers having an ethylenic bond as defined earlier, thereby forming free radicals. These radicals may in turn initiate the reaction for homopolymerization of the monomer or they may detach a hydrogen atom at the surface of a nanotube or a nanowire and thereby generate radicals at the surface of the nanotubes or nanowires which may also themselves initiate polymerization, thereby giving the possibility of having organic polymers grafted at the surface of the nanotubes or the nanowires. The polymerization reaction may therefore be accomplished in the absence of a photoinitiator.

The UV radiation applied during photografting has an intensity comprised between 50 and 600 Watts/cm², notably between 100 and 500 Watts/cm² and, in particular, of the order of 400 Watts/cm² (i.e. 400 Watts/cm²±50 Watts/cm²). The duration of the irradiation is comprised between 5 and 36 h and notably between 15 and 24 h.

Further information on the other grafting techniques which may be used during step (a) of the method may be obtained in the article of Fan et al., 2007 [29] and in the articles cited in the latter as well as in the article of Menzel et al. 2009 [29] for grafting an organic polymer activated with microwaves.

The thickness of the organic polymer may be easily controlled and this regardless of the applied alternative of the method of the present invention, as explained earlier. For each of the parameters such as the duration notably of steps (b₁) or (b₂) and depending on the reagents which he/she will use, one skilled in the art will be able to determine by iteration the optimum conditions for obtaining an organic polymer with a given thickness.

Any technique known by one skilled in the art for arranging a matrix between the thereby grafted (or functionalized or derivatized) nanotubes or nanowires and in particular between the nanotubes or nanowires aligned in the vertical matrix may be used within the scope of step (b) of the method according to the invention. This second step allows filling of the inter-nanotube or inter-nanowire residual space with a matrix as defined earlier.

The matrix forms an interpenetrated network with the adhesion layer grafted previously. For this, standard impregnation techniques may be used. As explained earlier, this interpenetration may be improved by chemisorption involving ionic and/or covalent bonds between organic polymer grafted on the nanotubes or the nanowires and the filling matrix. This chemisorption notably involves grafted polymers having at least one first reactive function as defined earlier and a filling matrix, the constitutive material of which has a second reactive function as defined earlier, both reactive functions being capable of reacting together in order to form an ionic or covalent bond.

In a first alternative of step (b) of the method, this step may consist in grafting the filling matrix following grafting of the organic polymer at the nanotubes or the nanowires. This alternative involves a filling matrix of the polymer type. In this case, the covalent bond between the organic polymer and the filling matrix is obtained as soon as the first unit of the polymeric material forming the filling matrix is grafted onto the organic polymer.

In a second alternative of step (b) of the method, this technique may be a chemical vapor deposition (CVD), an atomic layer deposition (ALD), a deposition by centrifugation known as [symbol] spin coating [symbol] ; an impregnation either assisted or not by pressure; a photo-impregnation; etc. . . . . The covalent or ionic bond between the organic polymer and the filling matrix is produced once the filling matrix is deposited in contact with the organic polymer.

Also, the filling matrix may be arranged in the whole space between the nanotubes or the nanowires or on the contrary in certain portions of this space, leaving other portions of free space between the nanotubes or the nanowires. Both of these alternatives and their benefits have been explained in the part [symbol] state of the prior art [symbol] .

The present invention also relates to the use of a material according to the present invention or of a material which may be prepared by a method according to the present invention, in a separation membrane, in a catalyst support, in an electrode, in a composite material or in a compound for storing or converting energy.

Indeed, the material according to the present invention or which may be prepared by a method according to the present invention may be used in many applications for which the density or the alignment of the nanotubes or of the nanowires, the selection of the material making up the filling matrix and the mechanical hold of the whole are the key elements for performances.

Thus, in the membrane applications for which the material according to the invention gives the possibility of making ultra-permeable nanoporous membranes, notably because of the alignment of the nanotubes which promotes flow of liquids and/or gases, allowing a wide range of filling and pressure-resistant matrices (as compared with membranes without any mechanically more fragile sub-layers). The present invention therefore relates to a membrane comprising a material according to the present invention or which may be prepared by a method according to the present invention, said material comprising at least two grafted nanotubes and a matrix arranged between the nanotubes. Such a membrane may be a filtration membrane, notably for desalting and demineralizing liquids and notably water.

In an application as a catalyst support, the function of the adhesion sub-layer of the material according to the invention plays a double role for maintaining alignment which gives the possibility of introducing more easily and over a greater depth, the catalytic elements into the lumen of the nanotubes, while ensuring a more substantial mechanical hold. The present invention therefore relates to a catalyst support comprising a material according to the present invention or which may be prepared by a method according to the present invention. Such a catalyst support may be used in a laboratory reactor or in an industrial reactor notably for breaking down hydrazine, for synthesis of styrene, for oxidation of hydrogen sulfide into elemental sulfur or for converting or recovering volatile organic compounds (VOC).

The present invention relates to an electrode comprising a material according to the present invention or which may be prepared a method according to the present invention. An electrode according to the invention may be used for any types of applications such as intense currents, electrical cables, electrical storage devices, energy, dissipation radiators, thermoelectric devices, energy conversion systems (photovoltaic systems), nanogenerators, cell growth, biochips or biotechnologies for which straightness and alignment of the nanotubes is crucial for the flow of electric charges while ensuring via the filling matrix a reinforced mechanical hold.

The present invention finally relates to a so-called [symbol] 1D [symbol] composite material comprising a material according to present invention or which may be prepared via a method according to the present invention. Such a material promotes a particular function in the direction of the axis of the nanotubes or of the nanowires. This function may be mechanical, electrical, thermal, optical or adhesive. Further, the density and the alignment of the nanotubes or of the nanowires form the technical effect while ensuring that the composite material is better held mechanically, either in order to be inserted into composites of larger size or in order to be used as such.

### SHORT DESCRIPTION OF THE DRAWINGS

FIG. 1 shows the modification by grafting of a thin layer of organic polymers from a diazonium aryl salt and from a monomer which is polymerizable via a radical route on a carpet of aligned carbon nanotubes and then the impregnation by a polymeric matrix in accordance with the method according to the present invention.

FIG. 2 shows the improvement of the polymer/nanotubes interface of a membrane made from modified carbon nanotubes i.e. grafted with an adhesion layer consisting of organic polymers in accordance with the present invention (FIG. 2B) as compared with a membrane without any sub-layer (FIG. 2A).

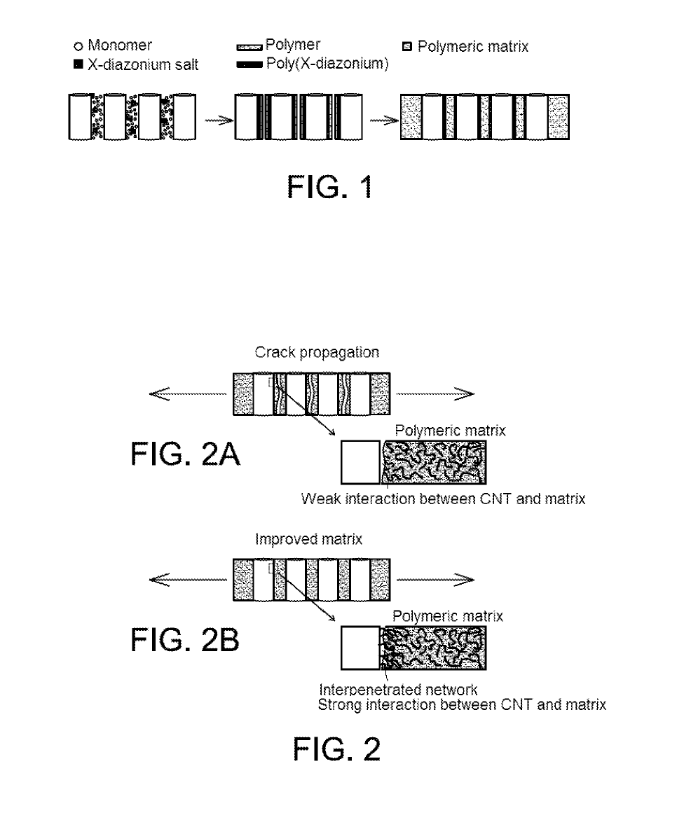

### DETAILED DISCUSSION OF PARTICULAR EMBODIMENTS

I. Photografting of Polystyrene (PS) on Carbon Nanotubes (CNT).

With this technique it is possible to obtain a layer of polystyrene covalently grafted on the external surface of the CNTs but also, by letting the homopolymerization styrene reaction continue to completion, in order to obtain a composite, the PS matrix of which is covalently bound to the aligned CNTs.

The CNT carpet prepared by CCVD of aerosol from a toluene/ferrocene mixture is placed in styrene degassed beforehand (the monomer covers the carpet). The formulation with CNTs is again placed under reduced pressure between −90 and −100 kPa for about 20 mins and under cold conditions i.e. between −10 and −30° C. The mixture is transferred into a closed test tube and placed under an inert atmosphere. The formulation is then irradiated with UVs (400 W global power of the bulb) for 15 to 24 h.

After irradiation, the carpet is recovered and then rinsed in THF in vacuo and under hot conditions of the order of 60° C.

II. Preparation of the Filling Matrix.

A styrene/benzoyl peroxide solution (1% by mass) is placed in a flask and then degassed under reduced pressure between −90 and −100 kPa for 45 min.

The modified carpet is added to the previous formulation. The whole is degassed under the same conditions for 30 mins. The solution and the carpet are transferred into a cylindrical Teflon® mould and then placed in a thermostatic oven at 60° C. for 20 hours.

### REFERENCES

[1] Hummer et al., 2001, [symbol] Water conduction through the hydrophobic channel of a carbon nanotube [symbol] , Nature, Vol. 414, pages 188-190.

[2] Hinds et al., 2004, [symbol] Aligned multiwalled carbon nanotube membranes [symbol] , Science, Vol. 303, pages 62-65.

[3] Pinault et al., 2005, [symbol] Evidence for sequential lift in growth of aligned multiwalled carbon nanotubes multilayers [symbol] , Nano letters, Vol. 5, pages 2394-2398.

[4] Holt et al., 2006, [symbol] Fast Mass Transport Through Sub-2-Nanometer Carbon Nanotubes [symbol] , Science, Vol. 312, pages 1034-1037.

[5] Kim et al., 2007, [symbol] Scalable Fabrication of Carbon Nanotube/Polymer Nanocomposite Membranes for High Flux Gas Transport [symbol] , Nano letters, Vol. 7, pages 2806-2811.

[6] Poh et al., 2009, [symbol] Fabrication and electrochemical behavior of vertically-aligned carbon nanotube electrodes covalently attached to p-type silicon via a thioester linkage [symbol] , Materials Letters, Vol. 63, pages 757-760.

[7] Oh et al., 2006, [symbol] Preparation of Aligned Carbon Nanotube Films Using the Langmuir-Blodgett Technique [symbol] , Int Conf Nanotech 2006.

[8] International application WO 2010/002805 filed in the name of Nanoasis Technologies and published on Jan. 7, 2010.

[9] International application WO 2007/025104 filed in the name of The regents of the University of California and published on Mar. 1, 2007.

[10] Wanliang Mi et al., 2007, [symbol] Vertically aligned carbon nanotube membranes on macroporous alumina supports [symbol] , Journal of Membrane Science, Vol. 304, pages 1-7.

[11] Park et al., 2008, [symbol] A High-Flux, Flexible Membrane with Parylene-encapsulated Carbon Nanotubes [symbol] , Int Conf Nanotech 2008.

[12] International application WO 2008/028155 filed in the name of Virginia Tech Intellectual Properties and published on Mar. 6, 2008.

[13] U.S. Pat. No. 7,611,628 filed in the name of University of Kentucky Research Foundation and issued on Nov. 3, 2009.

[14] Khare et Bose, 2005, [symbol] Carbon Nanotube Based Composites—A Review [symbol] , Journal of Minerals Materials Characterization Engineering, Vol. 4, pages 31-46.

[15] Mierczynska et al., 2007, [symbol] Electrical and mechanical properties of carbon nanotube/ultrahigh-molecular-weight polyethylene composites prepared by a filler prelocalization method [symbol] , Journal of Applied Polymer Science, Vol. 105, pages 158-168.

[16] Nan et al., 2003, [symbol] A simple model for thermal conductivity of carbon nanotube-based composites [symbol] , Chemical Physics Letters, Vol. 375, pages 666-669.

[17] Garcia et al., 2008, [symbol] Fabrication and multifunctional properties of a hybrid laminate with aligned carbon nanotubes grown in situ [symbol] , Composites Science and Technology, Vol. 68, 2034-2041.

[18] Patent application US 2004/0173506 filed in the name of Doktyez et al. and published on Sep. 9, 2004.

[19] International application WO 2009/141528 filed in the name of the Commissariat a l'Energie Atomique and published on Nov. 26, 2009.

[20] Pichot et al., 2006, [symbol] Structural and mechanical properties of single-wall carbon nanotube fibers [symbol] , Phys Rev. B, Vol. 74, pages 245416-245423.

[21] Bahr et al., 2002, [symbol] Covalent chemistry of single-wall carbon nanotubes [symbol] , J. Mater. Chem., Vol. 12, pages 1952-1958.

[22] Marcoux et al., 2004, [symbol] Electrochemical functionalization of nanotube films : growth of aryl chain on single-walled carbon nanotubes [symbol] , New J. Chem., Vol. 28, pages 302-307.

[23] Wang et al., 2005, [symbol] Microwave-induced rapid chemical functionalization of single-walled carbon nanotubes [symbol] , Carbon, Vol. 43, pages 1015-1020.

[24] Hu et al., 2003, [symbol] Sidewall functionalisation of single-walled carbon nanotubes by addition of dichlorocarbene [symbol] , J. Am. Chem. Soc., Vol. 125, pages 14893-14900.

[25] International application WO 2008/078052 filed in the name of the Commissariat à l'Energie Atomique and published on Jul. 3, 2008.

[26] Mévellec et al., 2007, [symbol] Grafting polymers on surfaces: a new powerful and versatile diazonium salt-based one-step process in aqueous media [symbol] , Chem. Mater., Vol. 19, pages 6323-6330.

[27] Lyskawa et Bélanger, 2006, [symbol] Direct Modification of a Gold Electrode with Aminophenyl Groups by Electrochemical Reduction of in Situ Generated Aminophenyl Monodiazonium Cations [symbol] , Chem. Mater., Vol. 18, pages 4755-4763.

[28] Tessier et al., 2008, [symbol] Grafting organic polymer films on surfaces of carbon nano-tubes by Surface Electroinitiated Emulsion Polymerization [symbol] , Physica Status Solidi A, Vol. 205, pages 1412-1418.

[29] Fan et al., 2007, [symbol] Synthesis of polymer grafted carbon nanotubes by nitroxide mediated radical polymerization in the presence of spin*-labeled carbon nanotubes [symbol] , Macromolecular Nanotechnology, Vol. 43, pages 26-34.

[30] Menzel et al., 2009, [symbol] Inverse Gas Chromatography of As-Received and Modified Carbon Nanotubes [symbol] , Langmuir, Vol. 25(14), pages 8340-8348.

[31] Pichot et al., 2004, [symbol] Evidence of strong nanotube alignment and for iron preferential growth axis in multiwalled carbon nanotube carpets [symbol] , Applied Physics Letters, Vol. 85, pages 473-475.

1.-12. (canceled)

13. A material comprising:
nanotubes or nanowires aligned with each other in a vertical matrix and
a matrix arranged between the nanotubes or the nanowires, at least one organic polymer being grafted covalently, to at least two of said nanotubes or at least two of said nanowires.

14. The material according to claim 13, wherein said nanotubes are inorganic nanotubes.

15. The material according to claim 14, wherein said inorganic nanotubes are selected from the group consisting of imogolite nanotubes, boron nitride (BN) nanotubes, zinc oxide (ZnO) nanotubes, gallium nitride (GaN) nanotubes, silicon nitride (Si₃N₄) nanotubes, tungsten bisulfide (WS₂) nanotubes, molybdenum bisulfide (MoS₂) nanotubes, tungsten selenide (WSe₂) nanotubes, molybdenum selenide (MoSe₂) nanotubes, titanium dioxide (TiO₂) nanotubes, molybdenum trioxide (MoO₃) nanotubes and one of their mixtures.

16. The material according to claim 13, wherein said nanotubes are organic nanotubes.

17. The material according to claim 16, wherein said organic nanotubes are selected from the group consisting of carbon nanotubes, peptide nanotubes, cyclic peptide nanotubes, transmembrane molecule nanotubes, crown ether nanotubes, porphyrin nanotubes, aquaporin nanotubes, gramicidin nanotubes, polymer nanotubes, nanotubes formed by self-assembly of organic molecules and one of their mixtures.

18. The material according to claim 13, wherein the nanowires are selected from the group consisting of gold (Au) nanowires, silver (Ag) nanowires, nickel (Ni) nanowires, platinum (Pt) nanowires, silicon (Si) nanowires, gallium nitride (GaN) nanowires, indium phosphide (InP) nanowires, silicum dioxide (SiO₂) nanowires, titanium dioxide (TiO₂) nanowires, zinc oxide (ZnO) nanowires, 1,5-diaminoanthraquinone nanowires, DNA ( [symbol] DeoxyriboNucleic Acid [symbol] ) nanotubes, nanowires consisting of nanotubes and one of their mixtures.

19. The material according to claim 13, having a density comprised between 10⁴ to 10¹³ nanotubes (or nanowires)/cm².

20. The material according to claim 13, wherein said organic polymer comprises:
at least one unit derived from a cleavable aryl salt, and/or
at least one unit derived from a monomer having at least one bond of the ethylenic type, and/or
at least one unit derived from a monomer having at least two carboxylic functions, and/or
at least one unit derived from a monomer having at least two amine functions, and/or
at least one unit derived from a monomer having a carboxylic function and an amine function.

21. The material according to claim 13, wherein said organic polymer is substituted with at least one reactive function selected from a carboxyl function, an aryl group, a radical entity, a hydroxyl function, an alcohol function, an amine function, an ester function, an aldehyde function, a hydrazide function, a ketone function, an epoxy function, an isocyanate function, a maleimide function, a diene function and a thiol function.

22. The material according to claim 20, wherein said organic polymer is substituted with at least one reactive function selected from a carboxyl function, an aryl group, a radical entity, a hydroxyl function, an alcohol function, an amine function, an ester function, an aldehyde function, a hydrazide function, a ketone function, an epoxy function, an isocyanate function, a maleimide function, a diene function and a thiol function.

23. The material according to claim 13, wherein said matrix is selected from the group consisting of a ceramic matrix, a polymer matrix, a matrix stemming from biomass, a matrix stemming from cellulose derivatives and mixtures thereof.

24. The material according to claim 13, wherein the material making up the matrix is substituted with at least one reactive function selected from a carboxyl function, an aryl group, a radical entity, a hydroxyl function, an alcohol function, an amine function, an ester function, an aldehyde function, a hydrazide function, a ketone function, an epoxy function, an isocyanate function, a maleimide function, a diene function and a thiol function.

25. A method for preparing a material according to claim 13, wherein said method comprises the successive steps of:
a) grafting, on at least two nanotubes from nanotubes aligned with each other in a vertical matrix or on at least two nanowires from nanowires aligned with each other in a vertical matrix, an either identical or different organic polymer,
b) arranging between the nanotubes or the nanowires obtained following step (a), a matrix.

26. The method according to claim 25, wherein the grafting applied during step (a) is selected from functionalization of the nanotubes or of the nanowires followed by coupling with an organic polymer; radical chemical grafting; electrografting; photografting; grafting by radical polymerization with transfer of atoms; grafting by radical polymerization controlled by nitroxide; grafting by radical polymerization by addition fragmentation; grafting in the vapor phase and grafting activated with microwaves.

27. Element comprising a material according to claim 13, wherein said element is selected in the group consisting of a separation membrane, a catalyst support, an electrode, a composite material and a compound for storing or converting energy.
